(19) United States
(12) Patent Application Publication
(10) Pub. No.: US 2018/0257909 A1
(43) Pub. Date: Sep. 13, 2018

(54) ELEVATOR CONTROL DEVICE

(71) Applicant: MITSUBISHI ELECTRIC CORPORATION, Chiyoda-ku (JP)

(72) Inventor: Chikashi YOSHIMURA, Chiyoda-ku (JP)

(73) Assignee: MITSUBISHI ELECTRIC CORPORATION, Chiyoda-ku (JP)

(21) Appl. No.: 15/571,122

(22) PCT Filed: Jun. 8, 2015
(86) PCT No.: PCT/JP2015/066458

§ 371 Date: Nov. 1, 2017

(51) Int. Cl. B66B 3/00; B66B 1/46

(52) U.S. Cl. CPC B66B 3/006; B66B 2201/463; B66B 2201/4623; B66B 1/468

(57) ABSTRACT

An elevator control device is configured to control a plurality of elevators disposed so as to provide an operation service to a plurality of floors. The elevator control device includes: a plurality of landing buttons, which are disposed at each of the floors, and to which an operating direction of the elevators is input; a car allocation unit configured to allocate one of the plurality of elevators to a landing call as a newly registered landing call each time the landing button is operated; and a drive control unit configured to provide the operation service of the allocated one of the plurality of elevators to the floor at which the landing call is generated.

### TECHNICAL FIELD

The present invention relates to an elevator control device, and more particularly, to an elevator control device configured to perform a group-control with respect to a plurality of elevators.

### BACKGROUND ART

There exists an elevator system including a group control device configured to control a plurality of elevators in a group. Each user registers a traveling direction by using a landing button before boarding a car. The registration is hereinafter referred to as “landing call registration”. The group control device dispatches an optimal car to each user based on the landing call registration.

It is assumed that a plurality of users separately operate the landing buttons for the same direction at the same floor in the elevator system described above. In this case, one car cannot be allocated to each of the users. In consideration of operational efficiency, one car is basically allocated to the plurality of users.

When the elevator is used in the night time and a building in which the elevators are installed is an apartment, however, the number of users is generally small. In such a case, for example, there is assumed a case in which the user desires to avoid riding in the same car with another user. In a general way, the user passes over the elevator car in which another user already rides so as to avoid riding in the same car. Then, the user registers a new landing call after departure of the elevator car.

In the “general way” described above, the user needs to wait for the departure of a preceding elevator car. Therefore, waiting time for the user becomes longer. Therefore, an elevator system described in Patent Literature 1 is configured to be capable of registering the landing call before the departure of the preceding elevator car. Specifically, in Patent Literature 1, a landing button is disposed in association with each elevator car in one-to-one correspondence. Further, in Patent Literature 1, the elevator system includes landing button determination means for determining whether or not the operated landing button is a landing button corresponding to an elevator car in a landed state. As a result of determination made by the landing button determination means, when the operated landing button corresponds to the elevator car in the landed state, a door of the elevator in the landed state is re-opened. Meanwhile, when the operated landing button does not correspond to the elevator in the landed state, the operation on the landing button is determined as new landing call registration. In this manner, the user can register the new landing call without waiting for the departure of the preceding elevator car. The “re-opening operation” herein means that the elevator door that is currently performing a door closing operation is reversed to be opened again or open time of the elevator door in the door open state is extended.

### CITATION LIST

### Patent Literature

[PTL 1] JP 2009-234786 A

### SUMMARY OF INVENTION

### Technical Problem

As described above, according to Patent Literature 1, one landing button is disposed for each elevator. Therefore, the number of landing buttons, which is equal to the number of elevators, are required. Therefore, there is a problem in that elevator installation cost disadvantageously increases.

Further, according to Patent Literature 1, the landing call for calling another elevator car can be registered only when the preceding elevator car is in the landed state. Specifically, when the preceding elevator car has not arrived yet, a new landing call for calling another elevator car cannot be registered. Therefore, with the elevator system described in Patent Literature 1, the arrival of the preceding elevator is required to be waited for so as to register a new landing call. This is equivalent to “need to wait for the departure of the preceding elevator car” in the above-mentioned “general way”. As described above, similarly to the above-mentioned “general way”, the elevator system described in Patent Literature 1 has a problem in its low responsiveness and low convenience.

The present invention has been devised to solve the problem described above, and has an object to provide an elevator control device capable of improving convenience by enhancing responsiveness when a user desires to avoid riding in the same car with another user.

### Solution to Problem

According to one embodiment of the present invention, there is provided an elevator control device, which is configured to control a plurality of elevators disposed so as to provide an operation service to a plurality of floors, the elevator control device including: a plurality of landing buttons, which are disposed at each of the plurality of floors, and to which an operating direction of the plurality of elevator cars is to be input; a car allocation unit configured to allocate one of the plurality of elevator cars to a landing call as a newly registered landing call each time one of the plurality of landing buttons is operated; and a drive control unit configured to provide the operation service of the allocated one of the plurality of elevator cars to one of the plurality of floors at which the landing call is generated.

### Advantageous Effects of Invention

With the elevator control device according to the present invention, each time the landing button is operated, one of a plurality of elevators is allocated to a landing call as a newly registered landing call car. In this manner, when a user desires to avoid riding in the same car with another user, a landing call for calling a next elevator car can be immediately registered without waiting for the departure or arrival of a preceding elevator car. Therefore, waiting time for the user can be prevented from increasing. Through enhancement of responsiveness in this manner, improvement of convenience can be achieved.

### BRIEF DESCRIPTION OF DRAWINGS

FIG. 1 is a configuration diagram for illustrating an elevator system including an elevator control device according to a first embodiment of the present invention.

FIG. 2 is a front view for illustrating a landing for the elevator system illustrated in FIG. 1.

FIG. 3 is a block diagram for illustrating an internal configuration of the elevator control device according to the first embodiment of the present invention.

FIG. 4 is a block diagram for illustrating a circuit configuration of the elevator control device according to the first embodiment of the present invention.

FIGS. 5A-5E are explanatory diagrams for illustrating an operation of the elevator control device according to the first embodiment of the present invention.

FIG. 6 is a flowchart for illustrating a flow of processing performed by the elevator control device according to the first embodiment of the present invention.

FIGS. 7A-7C are explanatory diagrams for illustrating a modification example of the operation of the elevator control device according to the first embodiment of the present invention.

### DESCRIPTION OF EMBODIMENT

Now, an embodiment for carrying out the present invention is described with reference to the drawings.

### First Embodiment

An elevator control device according to a first embodiment of the present invention can allocate different elevator cars to a plurality of users who are waiting for an elevator car at the same floor. A user can register a landing call for calling another elevator car without waiting for arrival and departure of a preceding elevator car. In this manner, the user can avoid riding in the same car with another user without increasing waiting time. Further, in the first embodiment, a landing button and a hall lantern are lit up in a different illumination color for each landing call registration made by each user. Based on the illumination color, each user can easily identify the elevator corresponding to his or her own landing call registration.

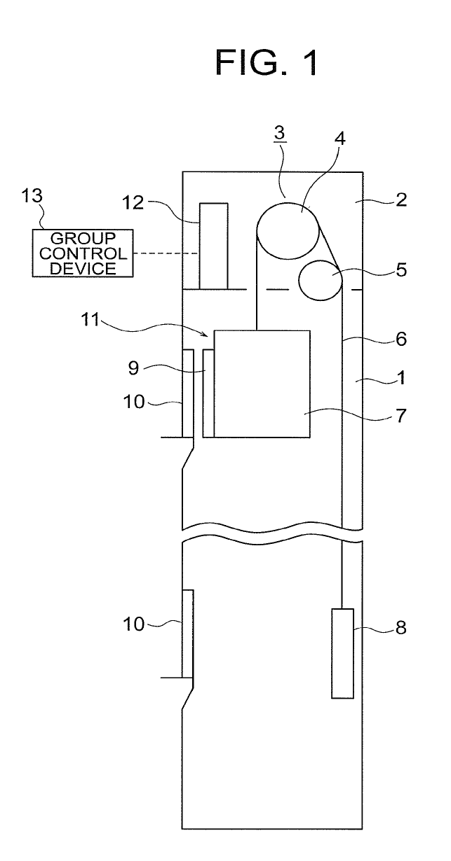

In FIG. 1, an elevator system according to the first embodiment is illustrated. Although a plurality of elevators are installed in a building, only one elevator is illustrated in FIG. 1 for simplification of the illustration. In the first embodiment, there is described an example in which four elevators are installed in the building. As illustrated in FIG. 1, a hoistway 1 is disposed for each elevator 11. In an upper part of the hoistway 1, a machine room 2 is installed. In the machine room 2, a hoisting machine 3 is installed. The hoisting machine 3 includes a driving sheave 4, a deflector sheave 5, a hoisting-machine motor (not shown) configured to rotate the driving sheave 4, and a hoisting brake (not shown) configured to brake the rotation of the driving sheave 4.

A hoisting rope 6 is looped around the driving sheave 4 and the deflector sheave 5. A car 7 is connected to one end of the hoisting rope 6. A counterweight 8 is connected to another end of the hoisting rope 6. The car 7 and the counterweight 8 are suspended by the hoisting rope 6 inside the hoistway 1. The car 7 and the counterweight 8 are raised and lowered by the hoisting machine 3 inside the hoistway 1.

A car door device 9 configured to open and close a car doorway is disposed to the car 7. Further, a landing door device 10 is disposed in a landing at each floor. When the car 7 lands, an opening and closing operation of the landing door device 10 is performed in conjunction with the car door device 9 through engagement between the car door device 9 and the landing door device 10 with each other.

In the machine room 2, a car control device 12 configured to control an operation of the elevator 11 is disposed. The car control device 12 is disposed for each elevator 11 in one-to-one correspondence. Therefore, in the first embodiment, four car control devices 12 are disposed for four elevators 11. Each of the car control devices 12 is connected to a single group control device 13. The group control device 13 is configured to perform a group-control with respect to the four elevators 11 to control operations of the four elevators 11.

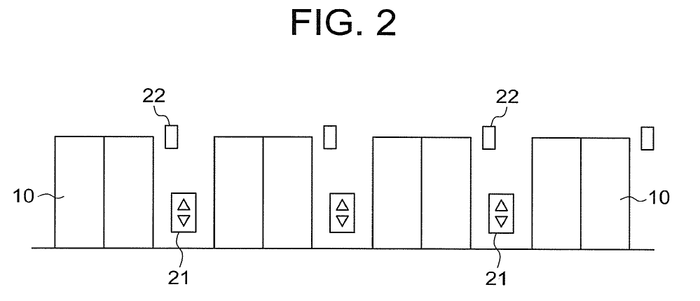

FIG. 2 is a front view for illustrating the landing for the elevator system illustrated in FIG. 1. On a landing wall, landing buttons 21 and hall lanterns 22 are disposed.

Each of the landing buttons 21 is a button to be operated by a user so as to register the landing call before the user boards the car 7. The landing button 21 includes an up landing button and a down landing button. The user operates the up landing button when desiring to go to an upper floor. The user operates the down landing button when desiring to go to a lower floor. In this manner, a desired operating direction is input on the landing button 21 by the user. The landing button 21 transmits, to the group control device 13, the operating direction and identification information indicating a position and a floor at which the landing button 21 is installed. The landing button 21 is disposed between the landing door devices 10. A plurality of the landing buttons 21 are disposed. However, the landing buttons 21 are not required to be disposed for each of the elevators 11. In the example of FIG. 2, a number m of the landing buttons 21 is three whereas the number of the elevators 11 is four. The number m may be set suitably.

The hall lantern 22 is disposed for each of the elevators 11. Therefore, in the example of FIG. 2, four hall lanterns 22 are disposed for the four elevators 11. Each of the hall lanterns 22 informs the user, who is waiting for the elevator in the landing, of arrival information of the car 7 of the corresponding elevator 11. The car arrival information contains two kinds of information, which are response information for informing allocation of the car 7 to the landing call registration and arrival information for informing the arrival of the car 7. The response information is indicated by lighting up the hall lantern 22. The arrival information is indicated by flashing on and off the hall lantern 22.

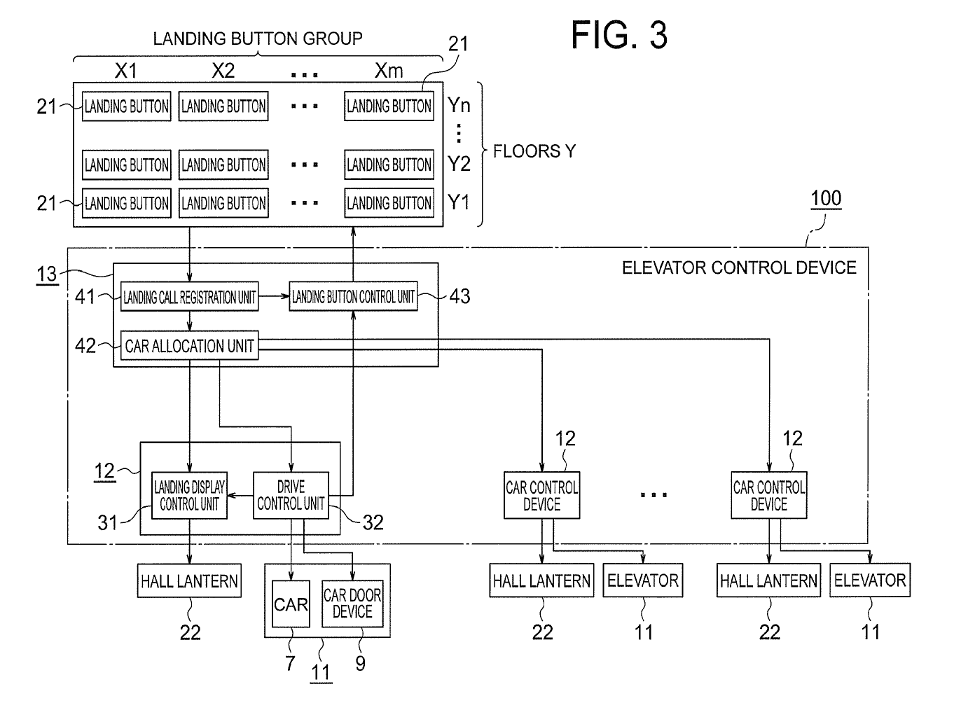

FIG. 3 is a block diagram for illustrating a configuration of an elevator control device 100 according to the first embodiment. As illustrated in FIG. 3, the elevator control device 100 includes the car control devices 12 and the group control device 13, which are illustrated in FIG. 1. As described above, the four car control devices 12 are disposed. In FIG. 3, however, only three of the car control devices 12 are illustrated for simplification of the illustration.

The landing buttons 21 are connected to the elevator control device 100. As illustrated in FIG. 3, m landing buttons 21 (X1, X2, . . . , Xm) are disposed for each of n floors (Y1, Y2, . . . , Yn). Therefore, the identification information indicating the position and the floor at which the landing button 21 is installed can be represented by coordinates (Xi, Yj), where 1≤i≤m and 1<j<n.

The group control device 13 includes a landing call registration unit 41, a car allocation unit 42, and a landing button control unit 43.

The landing call registration unit 41 receives the landing call registration based on information transmitted from the landing button 21. The information transmitted from the landing button 21 contains information of the operating direction desired by the user and the identification information of the landing button 21. The landing call registration unit 41 transmits the information of the registered landing call to the car allocation unit 42. Further, the landing call registration unit 41 determines whether the operation of the landing button 21 is a “first operation” or a “second or subsequent operation” based on a current landing call registration condition.

Each time the car allocation unit 42 receives the information of the landing call from the landing call registration unit 41, the car allocation unit 42 recognizes the received landing call as a new landing call to be registered. Further, the car allocation unit 42 selects the optimal elevator 11 from the plurality of elevators 11 and allocates the optimal elevator 11 to the landing call. In this example, as a method of selecting the “optimal elevator 11”, the elevator for which the waiting time for the user is expected to be the shortest is selected based on the number of registered landing calls, the number of registered car calls, and a current position and the operating direction of each of the elevators.

The landing button control unit 43 controls a lighting-up operation and a lighting-off operation of the landing button 21. When the landing button 21 is operated, the landing button 21 is lit up. A result of determination of whether the operation performed on the landing button 21 is a “first operation” or a “second or subsequent operation” is input to the landing button control unit 43 from the landing call registration unit 41. The landing button control unit 43 selects the landing button 21 to be lit up based on the result of determination and lights up the selected landing button 21. Specifically, when the landing call registration unit 41 determines that the operation performed on the landing button 21 is the “first operation”, the landing button control unit 43 selects and lights up all the landing buttons 21. An illumination color in this case is a first illumination color. Meanwhile, when the landing call registration unit 41 determines that the operation performed on the landing button 21 is the “second or subsequent operation”, the landing button control unit 43 selects only the operated landing button 21 and lights up the selected landing button 21 in a second illumination color different from the first illumination color. Further, at timing of departure of the car 7 that has arrived in response to the landing call corresponding to the lit landing button 21, the landing button control unit 43 lights off the landing button 21.

Each of the car control devices 12 includes a landing display control unit 31 and a drive control unit 32.

The landing display control unit 31 is configured to control a lighting-up operation, a lighting-off operation, and a flashing operation of the hall lantern 22. Based on allocation information from the car allocation unit 42, the landing display control unit 31 lights up the hall lantern 22 corresponding to the allocated elevator 11. The illumination color at this time is set to the same illumination color as the illumination color of the landing button 21 lit up by the landing button control unit 43.

The drive control unit 32 is configured to control a raising and lowering operation for the car 7 of the elevator 11. Further, the drive control unit 32 is also configured to control an opening and closing operation of the car door device 9 of the car 7. The drive control unit 32 is configured to control the car 7 of the elevator 11 to run to a floor for which the landing call is registered, based on a command from the car allocation unit 42 of the group control device 13. After the car 7 lands, the drive control unit 32 engages the car door device 9 and the landing door device 10 with each other so as to open the door.

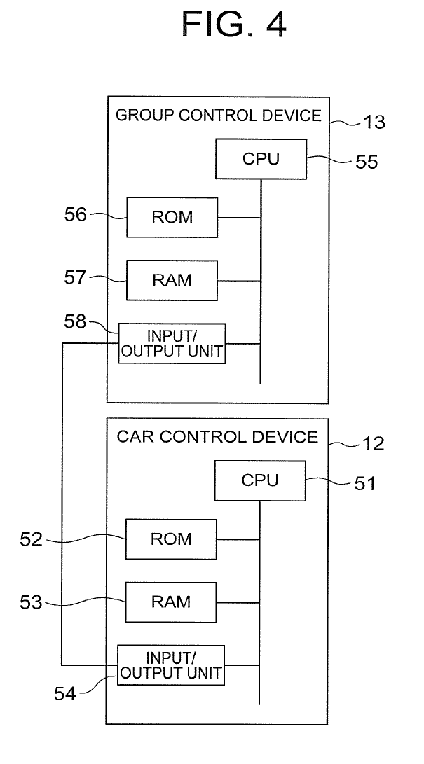

FIG. 4 is a block diagram for illustrating internal circuits of the car control device 12 and the group control device 13, which are illustrated in FIG. 1. In FIG. 4, for simplification of the illustration, only one car control device 12 is illustrated.

Each of the car control devices 12 includes a CPU 51, a ROM 52, a RAM 53, and an input/output unit 54. The input/output unit 54 is a transmitting and receiving device.

In the ROM 52, an operation program of the car control device 12 is stored. The CPU 51 is configured to execute calculation processing based on the operation program stored in the ROM 52. In the RAM 53, data necessary for the control is stored. A signal is input and output to/from the devices connected to the car control device 12, namely, the group control device 13, the hoisting machine 3, the hall lantern 22, the car door device 9, an in-car display device (not shown), and an in-car operating panel (not shown) via the input/output unit 54.

The landing display control unit 31 and the drive control unit 32 of the car control device 12 illustrated in FIG. 3 are achieved by the CPU 51 configured to execute the program stored in the ROM 52 and a processing circuit such as a system LSI. Further, functions of the landing display control unit 31 and the drive control unit 32 may be executed by a plurality of the processors and a plurality of memories in cooperation with each other.

The group control device 13 includes a CPU 55, a ROM 56, a RAM 57, and an input/output unit 58. The input/output unit 58 is a transmitting and receiving device.

In the ROM 56, an operation program of the group control device 13 is stored. The CPU 55 is configured to execute calculation processing based on the operation program stored in the ROM 56. In the RAM 57, data necessary for the control is stored. A signal is input and output to/from the devices connected to the group control device 13, namely, the car control devices 12 and the landing buttons 21 via the input/output unit 58.

The landing call registration unit 41, the car allocation unit 42, and the hall button control unit 43 of the group control device 13 illustrated in FIG. 3 are achieved by the CPU 55 configured to execute the program stored in the ROM 56 and a processing circuit such as a system LSI. Further, functions of the landing call registration unit 41, the car allocation unit 42, and the hall button control unit 43 may be executed by a plurality of the processors and a plurality of memories in cooperation with each other.

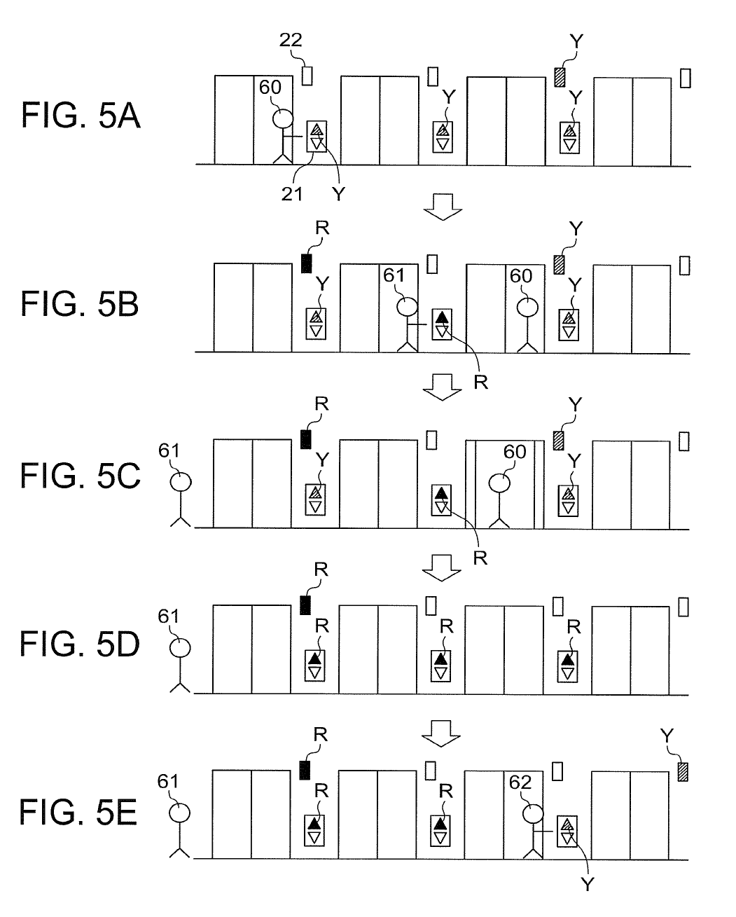

Next, with reference to FIG. 3 and FIGS. 5A-5E, an operation of the elevator control device 100 according to the first embodiment is described. FIGS. 5A-5E are operation explanatory diagrams, taking a case in which two landing calls are made as an example.

In FIGS. 5A-5E, yellow illumination is denoted by the reference symbol “Y”, and red illumination is denoted by the reference symbol “R”. In the example of FIGS. 5A-5E, there are only two kinds of illumination colors, specifically, yellow and red. The illumination colors are repeatedly used in turn in a specific order. Specifically, the illumination colors are used in turn in a specific order: yellow, red, yellow, red, and so on.

In FIGS. 5A-5E, it is assumed that there is currently no registered landing call in the elevator control device 100. Therefore, as illustrated in FIG. 2, all the landing buttons 21 are currently in a light-off state. Under this state, as illustrated in FIG. 5A, it is assumed that a first user 60 operates one landing button 21 of the plurality of landing buttons 21 to register a landing call. The landing call registration is hereinafter referred to as “first landing call registration”. Based on no currently registered landing call, the landing call registration unit 41 determines that the operation performed on the landing button 21 is the “first operation”. Based on the determination, the landing button control unit 43 lights up all the landing buttons 21 in yellow, which is the “first illumination color”. Simultaneously, the car allocation unit 42 selects the optimal elevator 11 for which the waiting time becomes the shortest and allocates the optimal elevator 11 to the “first landing call registration”. The car allocation unit 42 outputs the allocation information to the landing display control unit 31 and the drive control unit 32. Based on the allocation information, the landing display control unit 31 lights up the hall lantern 22 corresponding to the allocated elevator 11 in yellow, which is the “first illumination color”. The drive control unit 32 controls the car 7 of the allocated elevator 11 to start running.

Next, as illustrated in FIG. 5B, a second user 61 operates one landing button 21 of the plurality of landing buttons 21 to register a landing call. The landing call registration is referred to as “second landing call registration”. There is already one registered landing call, and therefore the landing call registration unit 41 determines that the operation performed on the landing button 21 is the “second or subsequent operation”. Based on the result of determination, the landing button control unit 43 lights up only the landing button 21 operated by the second user 61 in red, which is the “second illumination color”. Simultaneously, the car allocation unit 42 selects again the optimal elevator 11 for which the waiting time becomes the shortest for the “second landing call registration”, and allocates the selected elevator 11 to the landing call. Here, another elevator 11 other than the elevator 11 allocated to the “first landing call registration” is allocated to the “second landing call registration”. The car allocation unit 42 outputs the allocation information to the landing display control unit 31 and the drive control unit 32. The landing display control unit 31 lights up the hall lantern 22 corresponding to the elevator 11 allocated to the “second landing call registration” in red, which is the “second illumination color”, based on the allocation information output from the car allocation unit 42. The drive control unit 32 controls the car 7 of the allocated elevator 11 to start running.

Next, as illustrated in FIG. 5C, the drive control unit 32 controls the car 7 of the elevator 11 allocated to the “first landing call registration” to land. Further, the drive control unit 32 performs a door opening operation for the car 7. Then, the user 60 boards the car 7. The drive control unit 32 performs a door closing operation for the car 7. The drive control unit 32 controls the car 7 to depart. The drive control unit 32 outputs a notification signal for notifying the departure of the car 7 to the landing display control unit 31 and the landing button control unit 43.

Next, as illustrated in FIG. 5D, the landing display control unit 31 lights off the hall lanterns 22 lit in yellow, which is the “first illumination color”, based on the notification signal output from the drive control unit 32. The landing button control unit 43 lights off the landing buttons 21 lit in yellow, which is the “first illumination color”, and then lights up the landing buttons 21 in red, which is the “second illumination color”, based on the notification signal output from the drive control unit 32. As a result, all the landing buttons 21 are lit in red, which is the “second illumination color”.

Next, as illustrated in FIG. 5E, a third user 62 operates one landing button 21 of the plurality of landing buttons 21 to register a landing call. The landing call registration is referred to as “third landing call registration”. There is already one registered landing call, and therefore the landing call registration unit 41 determines that the operation performed on the landing button 21 is the “second or subsequent operation”. Based on the result of determination, the landing button control unit 43 lights up only the landing button 21 operated by the third user 62 in yellow, which is the “first illumination color”. Simultaneously, the car allocation unit 42 selects again the optimal elevator 11 for which the waiting time becomes the shortest for the “third landing call registration”, and allocates the selected elevator 11 to the landing call. Here, another elevator 11 other than the elevator 11 allocated to the “second landing call registration” is allocated to the “third landing call registration”. The car allocation unit 42 outputs the allocation information to the landing display control unit 31 and the drive control unit 32. The landing display control unit 31 lights up the hall lantern 22 corresponding to the elevator 11 allocated to the “third landing call registration” in yellow, which is the “first illumination color”. The drive control unit 32 controls the car 7 of the allocated elevator 11 to start running.

Although the two kinds of illumination colors, specifically, yellow and red, are used in the example of FIGS. 5A-5E, three or more kinds of illumination colors may be used. Further, yellow and red are mere examples, and suitable colors maybe used.

Further, when one different elevator 11 is allocated to each landing call registration as in the first embodiment, operation efficiency is lowered. Therefore, only in time such as night time in which the number of users is small, an operation in a “same-car avoidance mode” of the first embodiment maybe performed. In this case, an operation is performed in a “normal mode” during the remaining time. In the operation in the “normal mode”, one elevator 11 is allocated to the plurality of users who are present at the same floor as in the case of general elevators.

Further, in the first embodiment, it is supposed that the “second landing call registration” is performed before the arrival of the elevator 11 for the “first landing call registration”. As illustrated in FIG. 5C, however, the “second landing call registration” may be performed while the one elevator 11 is in a landed state. Such registration is effective not only for avoidance of a ride in the same car with another user but also for the following case. Specifically, for example, while the first user 60 is boarding the car 7, another user may perform the “second landing call registration” based on prediction that the car 7 may be fully loaded. A re-opening function of the door devices 9 and 10 with the landing buttons 21 is required to be disabled in this case.

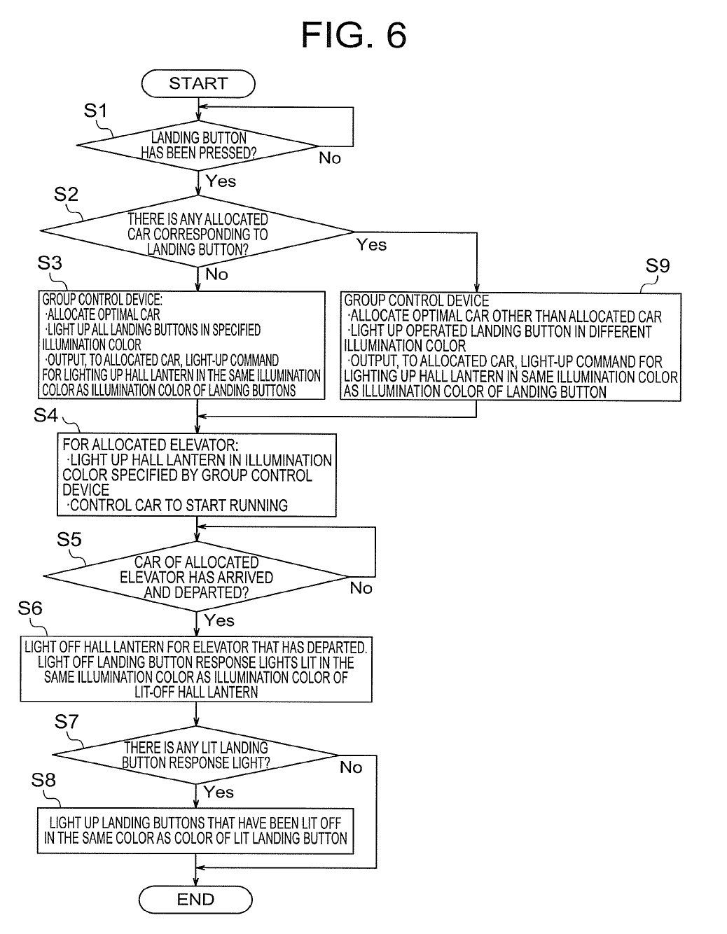

Next, with reference to a flowchart of FIG. 6, an operation of the elevator control device 100 according to the first embodiment is described.

As illustrated in FIG. 6, in Step S1, the elevator control device 100 first determines in the landing call registration unit 41 whether or not any one of the landing buttons 21 has been operated. When the landing call registration unit 41 detects that the one of the landing buttons 21 has been operated, the processing proceeds to Step S2. The processing in Step S1 is repeatedly carried out in constant cycles until the landing call registration unit 41 detects that the landing button 21 has been operated.

In Step S2, the landing call registration unit 41 determines whether or not there is already any elevator 11 that has been allocated to the landing call registration. Namely, the landing call registration unit 41 determines whether the current operation performed on the landing button 21 is the “first operation” or the “second or subsequent operation”. When the current operation is the “first operation”, the processing proceeds to Step S3. When the current operation is the “second or subsequent operation”, the processing proceeds to Step S9.

In Step S3, the car allocation unit 42 allocates the optimal elevator 11 in response to the operation on the landing button 21, which is performed in Step S1. The landing button control unit 43 lights up all the landing buttons 21 in the “first illumination color”. Further, the car allocation unit 42 outputs a light-up command to the landing display control unit 31 so as to light up the hall lantern 22 corresponding to the allocated elevator 11 in the “first illumination color”. After end of the processing in Step S3, the processing proceeds to Step S4.

In Step S9, the car allocation unit 42 allocates the optimal elevator 11 in response to the operation on the landing button 21, which is performed in Step S1. At this time, in Step S9, there is already the allocated elevator 11 for the operation performed on the landing button 21, and therefore another elevator 11 is allocated. The landing button control unit 43 lights up only the landing button 21 operated in Step S1 in the “second illumination color”. Further, the car allocation unit 42 outputs a light-up command to the landing display control unit 31 so as to light up the hall lantern 22 corresponding to the allocated elevator 11 in the “second illumination color”. After end of the processing in Step S9, the processing proceeds to Step S4.

In Step S4, the landing display control unit 31 lights up the hall lantern 22 corresponding to the allocated elevator 11 in the “first illumination color” or the “second illumination color” based on the light-up command from the car allocation unit 42 in Step S3 or Step S9. Further, the drive control unit 32 controls the car 7 of the allocated elevator 11 to start running based on the allocation information output from the car allocation unit 42.

Next, in Step S5, the drive control unit 32 determines whether or not the car 7 has arrived and departed. When the car 7 has departed, the notification signal for notifying the departure of the car 7 is output to the landing display control unit 31 and the landing button control unit 43. Then, the processing proceeds to Step S6. Meanwhile, when the car 7 has not departed yet, the processing in Step S5 is repeated until the car 7 departs.

Next, in Step S6, the landing display control unit 31 lights off the hall lantern 22 that has been lit in the “first illumination color” corresponding to the departing car 7 based on the notification signal from the drive control unit 32. Further, the landing button control unit 43 lights off the landing buttons 21 that have been lit in the “first illumination color” based on the notification signal from the drive control unit 32.

Next, in Step S7, the landing button control unit 43 determines whether or not there is any currently lit landing button 21. When there is any lit landing button 21, the processing proceeds to Step S8. Meanwhile, when there is no lit landing button 21, the processing is terminated after this step.

In Step S8, the landing button control unit 43 lights up again the landing buttons that have been lit off in Step S6 in the same illumination color as the illumination color of the lit landing button 21 detected in Step S7. After the end of the processing in Step S8, the processing returns to Step S1. In this manner, the flow of FIG. 6 is repeatedly executed.

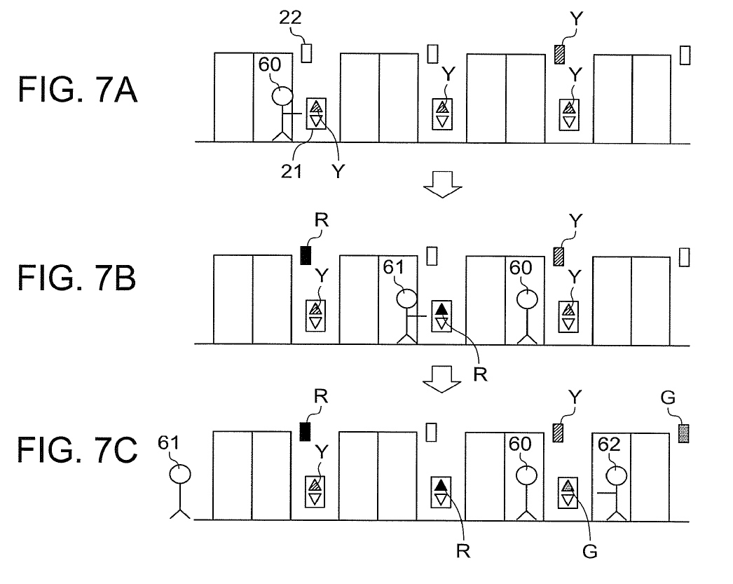

FIGS. 7A-7C are operation explanatory diagrams of an example in which three landing calls are made during the operation of the elevator control device 100 according to the first embodiment. In FIGS. 7A-7C, yellow illumination is denoted by the reference symbol “Y”, red illumination is denoted by the reference symbol “R”, and green illumination is denoted by the reference symbol “G”.

In the example of FIGS. 7A-7C, three types of illumination colors, namely, yellow, red, and green are used. These illumination colors are repeatedly used in turn in a specific order. Specifically, the illumination colors are repeatedly used in turn in a specific order: yellow, red, green, yellow, red, green, yellow, and so on.

The operation of FIGS. 7A-7C follows the flow of FIG. 6. Therefore, the operation of FIGS. 7A-7C is basically the same as that of FIGS. 5A-5E. FIGS. 7A-7C differ from FIGS. 5A-5E in that three kinds of illumination colors are used. Therefore, only an operation in Step S8 of FIG. 6 is slightly different. In the example of FIGS. 7A-7C, the operation in Step S8 is as follows. Namely, “when the currently lit landing buttons 21, which have been detected in Step S7, are lit up in two kinds of illumination colors, the landing button control unit 43 lights up again the landing button that has been lit off in Step S6 in the same illumination color as that of the currently lit landing button 21 that had been first lit up”. More specifically, when it is assumed that the landing button 21 lit in yellow is lit off in Step S6, in a case where the illumination colors of the currently lit landing buttons 21 are two kinds being red and green at that time, the landing button 21 that has been lit off in Step S6 is lit up in red, which is the same color as that of the first lit landing button 21. The remaining operation is the same as that in the description given above with reference to FIG. 6.

In the following, the operation of FIGS. 7A-7C is briefly described. For details, the description given above for FIGS. 5A-5E and FIG. 6 is referred to.

In FIGS. 7A-7C, it is assumed that there is currently no registered landing call in the elevator control device 100. Therefore, all the landing buttons 21 are currently in a light-off state. Under this state, as illustrated in FIG. 7A, the first user 60 operates one landing button 21 of the plurality of landing buttons 21 to perform the “first landing call registration”. In response to the operation, the landing button control unit 43 lights up all the landing buttons 21 in yellow, which is the “first illumination color”. Simultaneously, the car allocation unit 42 selects the optimal elevator 11 for which the waiting time becomes the shortest and allocates the optimal elevator 11 to the “first landing call registration”. The car allocation unit 42 outputs the allocation information to the landing display control unit 31 and the drive control unit 32. Based on the allocation information, the landing display control unit 31 lights up the hall lantern 22 corresponding to the allocated elevator 11 in yellow, which is the “first illumination color”. The drive control unit 32 controls the car 7 of the allocated elevator 11 to start running.

Next, as illustrated in FIG. 7B, the second user 61 operates one landing button 21 of the plurality of landing buttons 21 to perform the “second landing call registration”. In response to the operation, the landing button control unit 43 lights up only the landing button 21 operated by the second user 61 in red, which is the “second illumination color”. Simultaneously, the car allocation unit 42 selects again the optimal elevator 11 for which the waiting time becomes the shortest for the “second landing call registration”, and allocates the selected elevator 11 to the landing call. The landing display control unit 31 lights up the hall lantern 22 corresponding to the elevator 11 allocated to the “second landing call registration” in red, which is the “second illumination color”. The drive control unit 32 controls the car 7 of the allocated elevator 11 to start running.

Next, as illustrated in FIG. 7C, the third user 62 operates one landing button 21 of the plurality of landing buttons 21 to register a landing call. The landing call registration is referred to as “third landing call registration”. There are already two registered landing calls, and therefore the landing call registration unit 41 determines that the operation performed on the landing button 21 is the “second or subsequent operation”. Based on the result of determination, the landing button control unit 43 lights up only the landing button 21 operated by the third user 62 in green, which is the “third illumination color”. Simultaneously, the car allocation unit 42 selects again the optimal elevator 11 for which the waiting time becomes the shortest for the “third landing call registration”, and allocates the selected elevator 11 to the landing call. Another elevator 11 other than the elevator 11 allocated to the “second landing call registration” is allocated to the “third landing call registration”. The landing display control unit 31 lights up the hall lantern 22 corresponding to the elevator 11 allocated to the “third landing call registration” in green, which is the “third illumination color”. The drive control unit 32 controls the car 7 of the allocated elevator 11 to start running.

In the description given above, the third user 62 operates one landing button 21 of the plurality of landing buttons 21 to register the landing call. At this time, however, it is assumed that the operation performed by the user becomes valid only for the plurality of landing buttons 21 that are lit in a single illumination color. When only one landing button 21 is lit in the single illumination color, the operation performed on the landing button 21 is disabled. Specifically, description is given for the example of FIG. 7B. There are two landing buttons 21 that are lit in yellow being the “first illumination color”, the operation by the user is valid for the landing buttons 21 that are lit in yellow. Meanwhile, only one landing button 21 is lit in red being the “second illumination color”. Thus, the operation by the user is disabled for the landing button 21 that is lit in red.

In the example of FIGS. 7A-7C, the case in which the three kinds of illumination colors are used is described. However, even when four or more kinds of illumination colors are used, the operation is the same as the example of FIGS. 7A-7C. Further, yellow, red, and green are mere examples, and suitable colors may be used.

As described above, in the elevator control device 100 according to the first embodiment, the plurality of landing buttons 21 to which an operating direction of the elevator 11 is input are disposed for each floor. Each time the landing button 21 is operated, the car allocation unit 42 allocates one elevator as a newly registered landing call. In this manner, the drive control unit 32 operates the allocated elevator 11 to serve a floor at which the landing call is generated.

In this manner, in the elevator control device 100 according to the first embodiment, each time the landing button 21 is operated, one elevator 11 selected from the plurality of elevators is allocated to the landing call as a newly registered landing call. In this manner, when the user desires to avoid riding in the same car with another user, a landing call for calling the next elevator 11 can be immediately registered without waiting for the departure or arrival of the preceding elevator 11. Therefore, the waiting time for the user can be prevented from increasing. In this manner, improvement of convenience of the elevator 11 can be achieved by enhancing responsiveness of a same-car avoidance operation.

Further, each time the landing button 21 is operated, the landing button control unit 43 lights up the operated landing button 21 in one illumination color selected in turn from the plurality of illumination colors. Further, the landing display control unit 31 lights up the hall lantern 22 corresponding to the elevator 11 allocated by the car allocation unit 42 in the same illumination color as the illumination color of the operated landing button 21. Each user can identify the elevator 11 corresponding to the landing call registered by his or her own operation based on the illumination color, and therefore can be prevented from erroneously boarding the elevator 11 corresponding to the landing call registered by another user.

Further, after the elevator 11 allocated by the car allocation unit 42 arrives at a floor at which the landing call is generated and departs from the floor, the landing display control unit 31 lights off the hall lantern 22 corresponding to the elevator 11. Further, the landing button control unit 43 lights off the landing button 21 being lit in the same illumination color as that of the hall lantern 22 that has been lit off. Further, when there are any landing buttons 21 being lit in another illumination color, the landing button control unit 43 lights up again the landing button 21 that has been lit off in the same illumination color as the illumination color of the first lit landing button 21 among the landing buttons 21. In this manner, when the landing button 21 is operated subsequently, the illumination color that is just lit off can be used again. Thus, even when the number of kinds of illumination colors is small, the elevator 11 can be identified based on the illumination color.

1. An elevator control device, which is configured to control a plurality of elevators disposed so as to provide an operation service to a plurality of floors, and which allows a user to register a new landing call independently of a landing call registered previously by another user when the plurality of elevators are operated in a same-car avoidance mode, the elevator control device comprising:
a plurality of landing buttons, which are disposed at each of the plurality of floors, and to which an operating direction of each of the plurality of elevators is to be input;
a car allocation unit configured to allocate one of the plurality of elevators to a landing call as a newly registered landing call each time one of the plurality of landing buttons is operated when the plurality of elevators are operated in the same-car avoidance mode; and
a drive control unit configured to provide the operation service of the allocated one of the plurality of elevators to one of the plurality of floors at which the landing call is generated.

2. The elevator control device according to claim 1, further comprising:
a landing button control unit configured to control lighting-up operations of the plurality of landing buttons;
a hall lantern, which is disposed for each of the plurality of elevators in one-to-one correspondence at each of the plurality of floors, and which is configured to display arrival information of a corresponding one of the plurality of elevators; and
a landing display control unit configured to control a lighting-up operation of the hall lantern,
wherein, when the plurality of elevators are operated in the same-car avoidance mode, each time one of the plurality of landing buttons is operated, the landing button control unit lights up the operated one of the plurality of landing buttons in one illumination color selected in turn from a plurality of illumination colors, and
wherein the landing display control unit is configured to light up the hall lantern corresponding to the one of the plurality of elevators allocated by the car allocation unit in the same illumination color as the one illumination color of the operated one of the plurality of landing buttons.

3. The elevator control device according to claim 2, wherein, when the one of the plurality of elevators allocated by the car allocation unit arrives at one of the plurality of floors at which the landing call is generated and then departs from the one of the plurality of floors, the landing display control unit lights off the hall lantern corresponding to the allocated one of the plurality of elevators, and the landing button control unit lights off one of the plurality of landing buttons being lit in the same illumination color as an illumination color of the hall lantern that has been lit off, and when there are landing buttons being lit in others of the plurality of illumination colors, lights up the lit-off landing button again in the same illumination color as an illumination color of the landing button that has been first lit up among the lit landing buttons.
